(19) United States
(12) Patent Application Publication
(10) Pub. No.: US 2015/0376874 A1
(43) Pub. Date: Dec. 31, 2015

(54) WATER LEAK DETECTION, PREVENTION AND WATER CONSERVATION SYSTEMS AND METHODS

(71) Applicant: Anthony Todd Breedlove, Land O Lakes, FL (US)

(72) Inventor: Anthony Todd Breedlove, Land O Lakes, FL (US)

(73) Assignee: Aqualock Global Corporation, St. Petersburg, FL (US)

(21) Appl. No.: 14/701,100

(22) Filed: Apr. 30, 2015

Related U.S. Application Data
(60) Provisional application No. 61/986,184, filed on Apr. 30, 2014.

(51) Int. Cl. E03B 7/00; G06Q 50/06; G06Q 20/14; G05D 7/06; F17D 5/06

(52) U.S. Cl. CPC E03B 7/003; G05D 7/0635; F17D 5/06; G06Q 20/145; G06Q 50/06

(57) ABSTRACT

A water leak detection and prevention system uses sensors, wires, and wireless transmitters, to monitor all plumbing fixtures (faucets, toilets, hose bibs, etc.) and water-using appliances (dishwashers, washing machines, icemakers, etc.). When water is being used at a plumbing fixture or a water-using appliance, the sensor shows water that is expected to be used at that location and communicates the usage and the amount of flow for that location. Excessive usage or flow, or any flow when a location has not called for water, is indicative of a leak. Water to the building is on all the time—water pressure remains in the plumbing—creating no delay in water delivery. Water pressure and water flow are monitored at all times whether water is off or on. Should a leak occur the water flow sensor will show that water is flowing and that no approved location has called for water. The main valve will immediately be turned off and water in the plumbing system will be purged safely outside the building. Plumbing system protection: Should an over-pressure situation occur—due to expanding water being heated for instance—system will evacuate a small amount of water to the outside of the building, protecting plumbing, fixtures and appliances. Temperature sensors placed on piping at strategic locations will protect plumbing from freezing. Should temperatures near the freezing point, the system will purge water from the pipes. Water conservation system: should a toilet flapper become stuck open or partially open, or a faucet left dripping or running, the system main valve will close and water will be conserved.

### RELATED APPLICATION

This application claims the benefit of U.S. Provisional Application No. 61/986,184 filed Apr. 30, 2014 bearing the same title and by the same inventors. U.S. Provisional Application No. 61/986,184 is hereby incorporated by reference as if repeated herein in its entirety, including the drawings.

### BACKGROUND

The present invention relates generally to methods and systems for detecting and preventing water leaks inside homes and businesses, as well as for conserving water and protecting plumbing systems from over-pressure and freezing. More particularly, the present invention relates to a method and system for detecting and preventing water leaks inside a home or business, and for conserving water and protecting the plumbing system from over-pressure and freezing by, inter alia, monitoring use of all water utilization devices.

Water leaks in homes cause $9.1 billion dollars in homes each year and $8.5 billion of that is preventable according to a study by ACE Private Risk Services (http://www.reuters.com/article/2014/03/25/pa-ace-private-risk-idUSnBw256563a+100+BSW20140325). A significant number of leaks occur due to frozen pipes. See http://www.claimsjournal.com/news/national/2011/04/08/184301.htm.

Moreover, over-pressure situations fatigue pipes, fixtures and appliances thereby leading to premature failure of such devices.

The EPA states that over 1 trillion gallons of water is wasted each year due to leaks in homes. “That's equivalent to the annual water use of Los Angeles, Chicago, and Miami combined!” http://blog.epa.gov/healthywaters/2011/08/the-real-worth-of-water/.

The present invention is therefore directed to the problem of developing a method and apparatus for preventing excess water usage and water leaks that damage homes or businesses, and for conserving water and protecting plumbing systems.

### SUMMARY OF THE INVENTION

The present invention solves these and other problems by providing a method and apparatus for water leak detection, prevention and water conservation that monitor water usage of each water utilization device in a home or business and detects when water usage falls outside expected levels.

One aspect of embodiments of the present invention prevents any substantial leak in a home or business by disconnecting the home or business building from the high pressure water line in the event of a leak in the plumbing system, plumbing fixtures or water-using appliances.

Another aspect of the embodiments of the present invention is that when there is water flow though the main water supply and a water fixture or water-using appliance is not demanding water, the embodiment will turn off the main supply, purge the plumbing system, sound an alarm and send a notification to the user' s cell phone.

Another aspect of the embodiments of the present invention is that anytime there is water flow though the main water supply and a water fixture or water-using appliance is demanding water, each water fixture or water-using appliance's maximum water flow rate, and usage quantity is recorded in the memory of the control panel, so that should the water flow rate or usage quantity exceed the allowed maximum, the system will turn off the main supply, purge the plumbing system, sound an alarm and send a notification to the user's cell phone and data concerning quantity of water being leaked will be reported to the system and available for the homeowner and plumber repairing the leak.

Another aspect of the embodiments of this invention is that anytime there is water flow though the main water supply and a water fixture or water-using appliance is demanding water, that water fixture or water-using appliance's maximum water flow rate, and usage quantity is recorded in the memory of the control panel; should multiple water fixtures and/or water-using appliances call for water during the same time frame, total pressure, flow and quantity are calculated for all of the fixtures and or appliances using water simultaneously; should usage exceed the maximum allowable for the combined fixtures and appliances, the system will turn off the main supply, purge the plumbing system, sound an alarm and send a notification to the user's cell phone.

Another aspect of the embodiments is that alarms can be monitored through a central monitoring facility and actions be taken to remedy the issue, such as calling responders (friends, neighbors, or relatives that have a key to the building and can check on the structure) or remotely purging the plumbing system.

Another aspect of the embodiments of the invention is that the system may be either all wireless or wired through a low-voltage wiring network, or any combination thereof.

Another aspect of the embodiments of the invention is that a periodic pressure test may be initiated during times when water is not being used. Therein the main water control valve will be closed and water pressure will be monitored for a time to see if any very small leaks are present. After the testing period has expired or water is called for from an authorized faucet or appliance the main water supply valve will immediately be opened.

Another aspect of embodiments of this invention is to stop water from flowing into the structure and purge the remaining water safely outside the building if:

1. Water flow exceeds the maximum allowable water flow to a single water fixture or water-using appliance.

2. Water flow exceeds the maximum allowable water flow to multiples water fixtures and/or water-using appliances at once.

3. All water usage is accounted for. Any water flow that is unaccounted for will cause the system to go into an alarm mode, shut off the water supply, and purge the remaining water safely outside the building.

Another aspect of embodiments of this invention is to protect the water system from freeze by:

1. Monitoring water temperature and sounding an alarm and notifying the user if water temperature drops to a freeze danger level.

2. Monitoring water temperature, inside air temperature, outside air temperature and/or predicted temperature for the geographical area, and sounding an alarm and notifying the user that a possible water supply freeze condition may exist.

3. During times when water is not being used, a brief plumbing system test will be initiated to detect slow leaks by turning off the main valve and checking for a drop in pressure over time. Should the pressure test fail, the system will go into an alarm mode, shut off the water supply and purge the remaining water safely outside the building and notify the user via cell message of a possible water supply issue.

Another aspect of embodiments of this invention is to prevent substantial water damage or water waste when the occupant or an appliance inadvertently demands water from the main when in fact such demand is due to the forgetfulness of the occupant to turn off a faucet, leaves a faucet dripping, a toilet flapper gets hung or an appliance fails to turn off its demand for water.

### BRIEF DESCRIPTION OF THE DRAWINGS

FIG. 1 is a view of a typical main water control unit installation in a garage.

FIG. 2 is a view of the main water control unit with a solenoid as the main water shutoff valve.

FIG. 2a is a view of the main water control unit with a separate motor controlled ball valve as the main water shutoff valve.

FIG. 3 is a view of sink with flow switches or flow sensors, and transmitter.

FIG. 4 is a view of kitchen sink with a motion detector.

FIG. 5 is a view of a kitchen sink with an electronic approach sensor and transmitter.

FIG. 6 is a view of a kitchen sink with a touch sensor.

FIG. 7 is a view of refrigerator with an inductive pickup and transmitter.

FIG. 8 is a view of hose bib with a button actuated transmitter.

FIG. 9 is a view of toilet with a tilt switch and transmitter.

FIG. 10 is a view of shower with a motion sensor.

FIG. 11 is a view of condensation drip pan with a moisture sensor and transmitter.

FIG. 12 is a view of bathroom sink with two one-way check valves installed.

FIG. 13 is a view of the control panel.

FIG. 14 is a view of a typical wireless retrofit on a house.

FIG. 15 is the logic flow chart outlining how the system works.

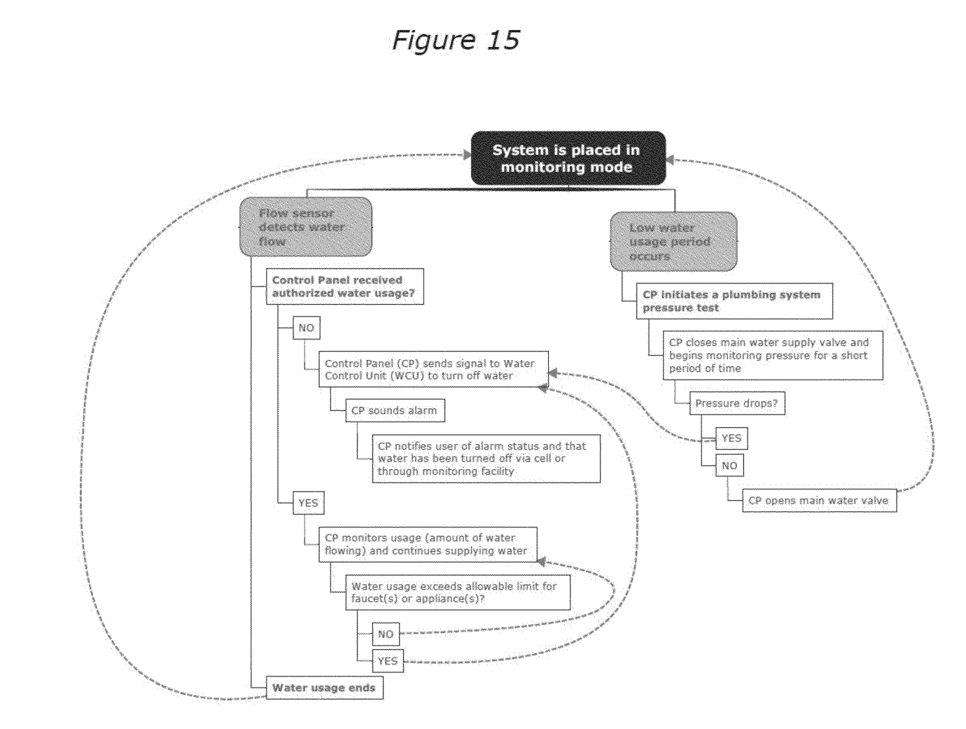

### DETAILED DESCRIPTION

Homes and businesses are at continual risk for damage due to supply line leaks and failures and appliance malfunctions. Damages can result in hundreds of thousands of dollars in damages, often significantly disrupting business operations or living situations. In homes, the occupants often need to move out of the home for a period of weeks or even months, in cases of substantial water damage. By way of contrast, water damages due to a leaking roof are typically less catastrophic because rain is infrequent, whereas water supply failure causes water to flow continuously and under high pressure 24 hours a day. Small leaks occurring behind walls, in ceilings, behind cabinets and in other non-visible locations can go on for weeks or months causing unseen damage and creating a fertile environment for health-damaging mold to grow. Large leaks can do tens of thousands of dollars in damages in a few hours.

The system outlined in this invention will substantially reduce or eliminate the possibility of damage due to a plumbing, water fixture or water-using appliance malfunction or leak.

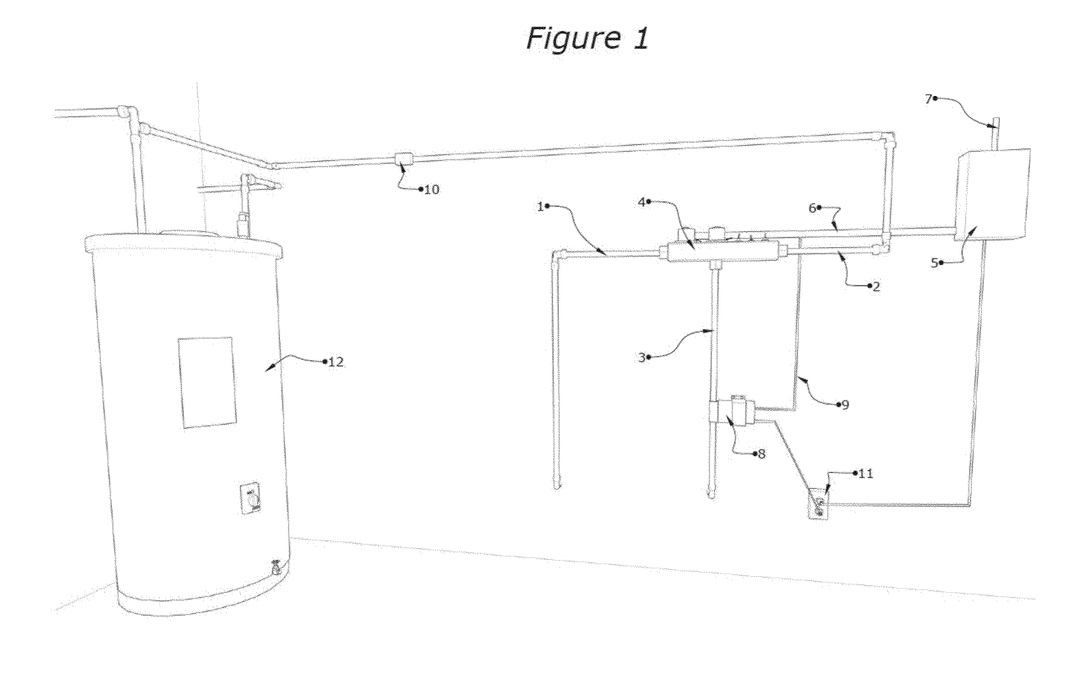

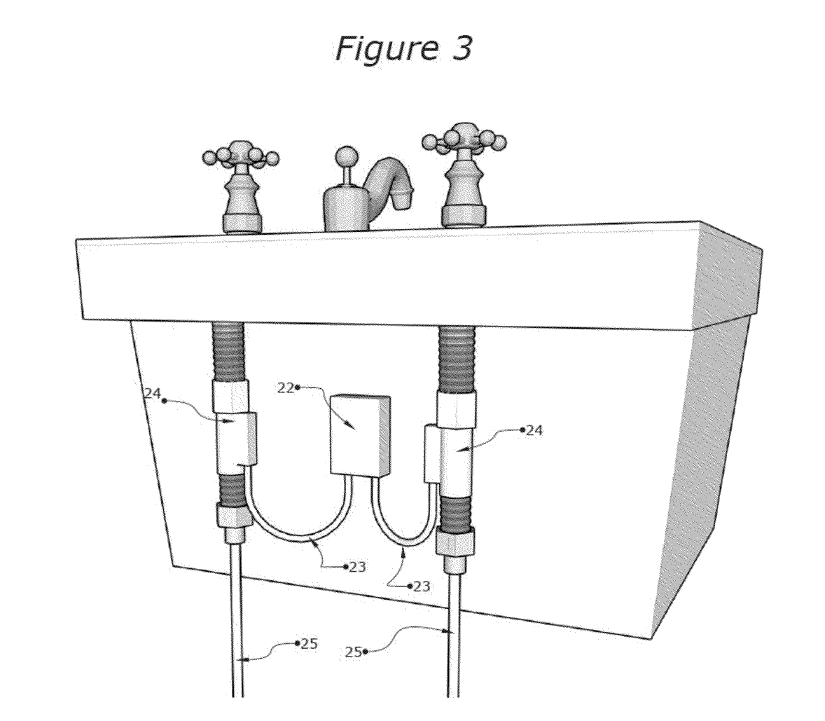

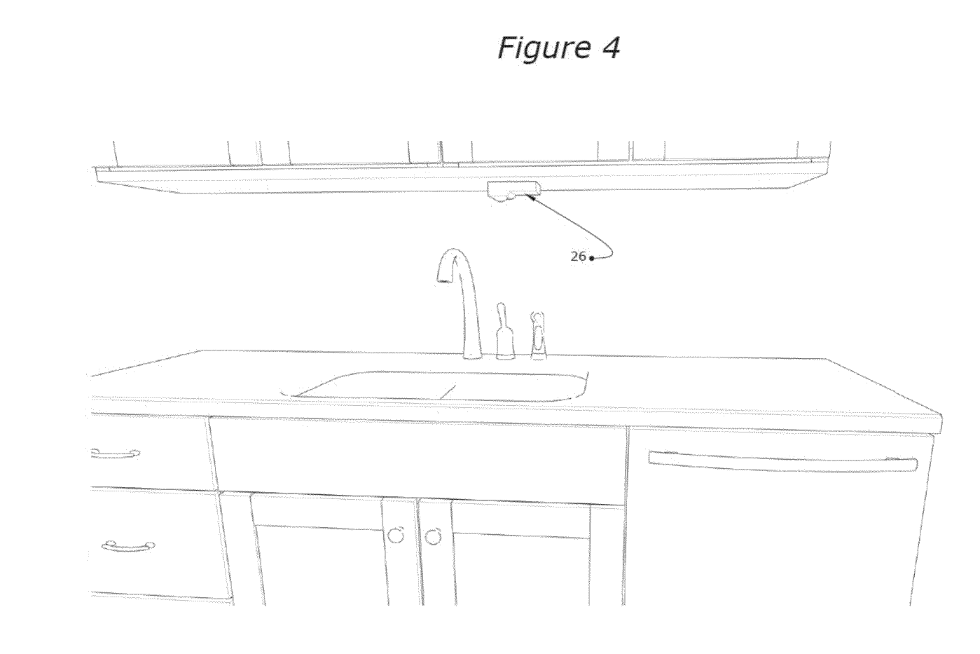

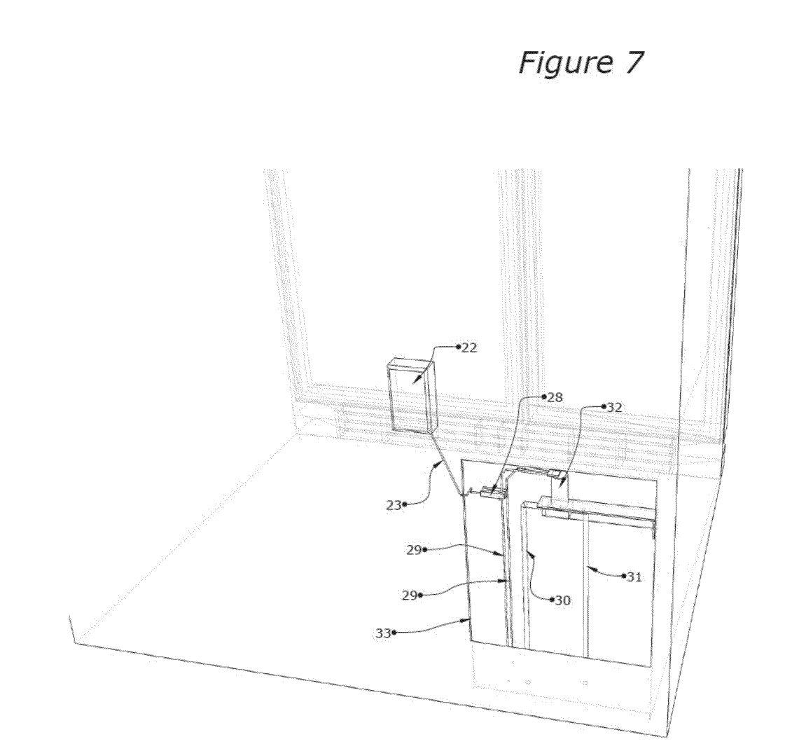

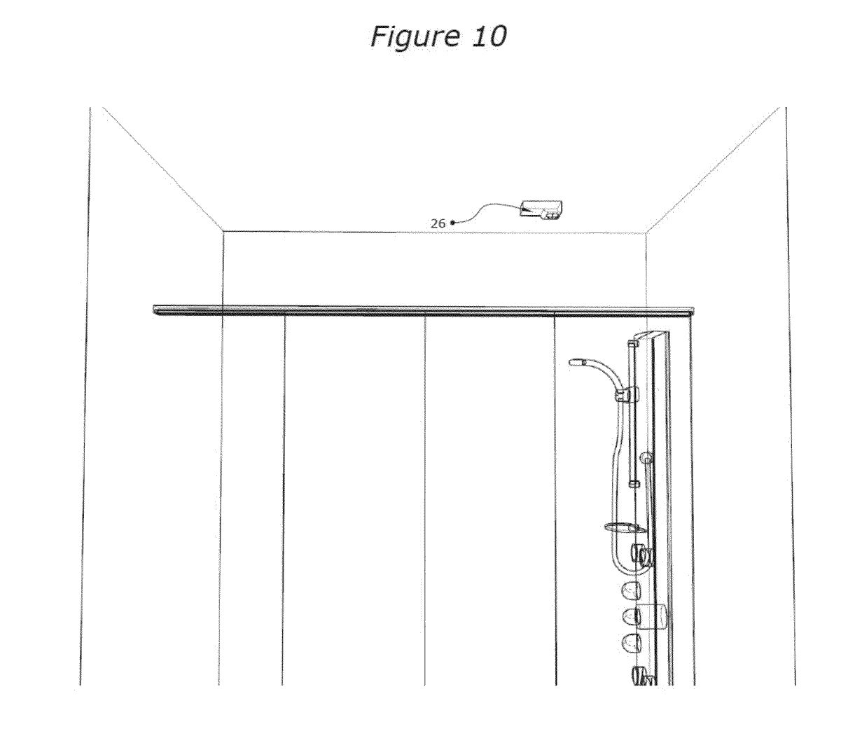

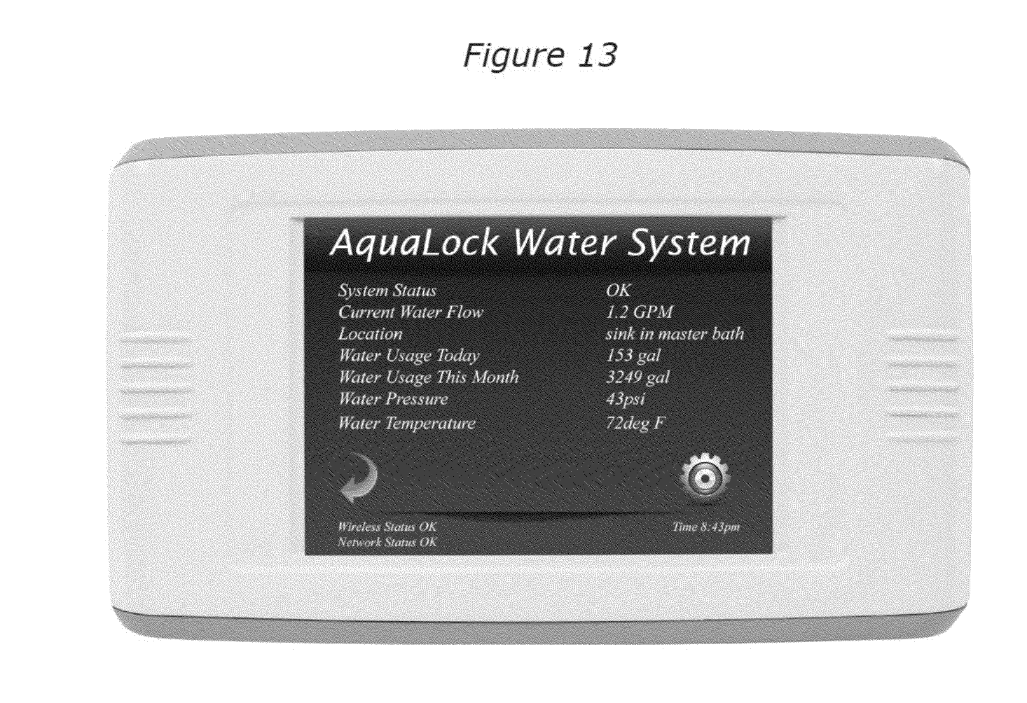

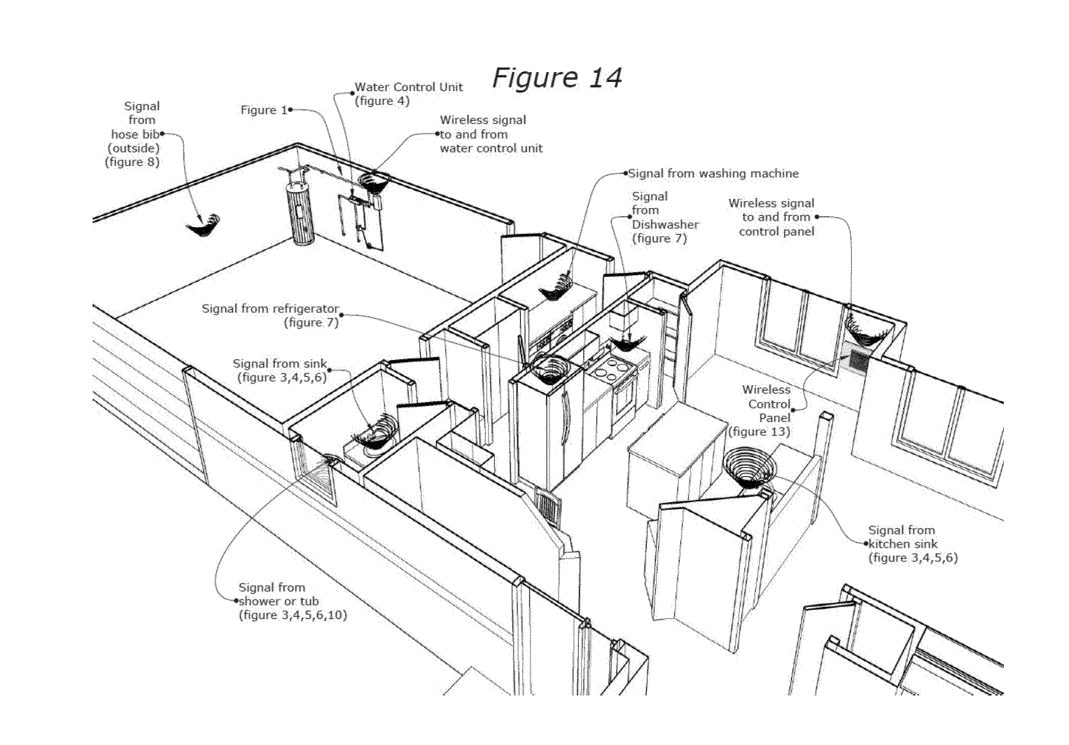

FIG. 14 illustrates a typical application of the invention in a home; a business installation will be similar. All faucets, plumbing fixtures and water-using appliances are connected to sensors, the sensors sense when water is used or will be used. The drawing depicts wireless transmitters but sensors can also be connected to the system by wires through a low voltage network. The installation of the water control unit may occur in the garage (see FIG. 1). The control panel (see FIG. 13) is located in any convenient spot in the living quarters. Each water-using appliance is connected to a transmitter (see FIG. 7). Each plumbing fixture is connected to a transmitter (see FIGS. 3, 4, 5, 6, 8 and 9). Showers, tubs and areas can be monitored through the use of motion sensors (see FIGS. 4 and 10) or through the other methods used in FIGS. 3, 4, 5, 6, 8 and 9, or by any type of sensing device connected to a transmitter or through the low-voltage network.

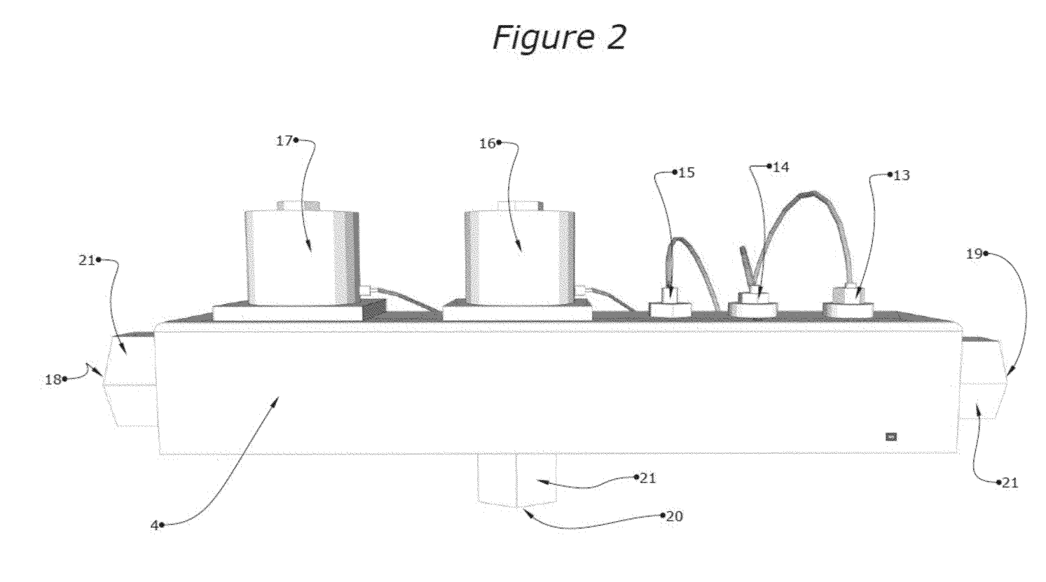

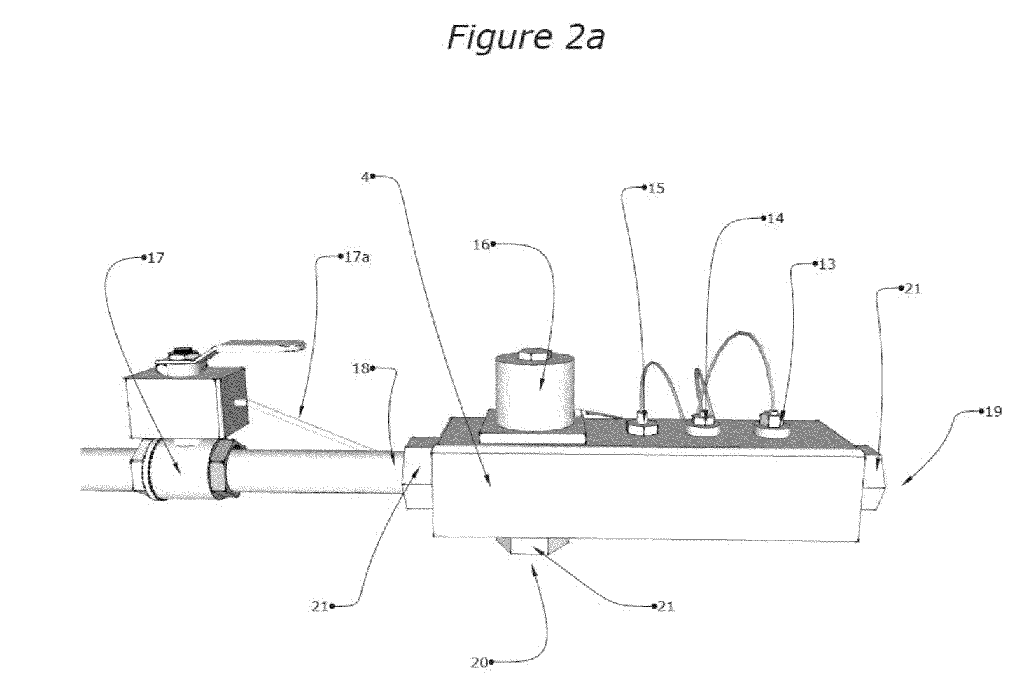

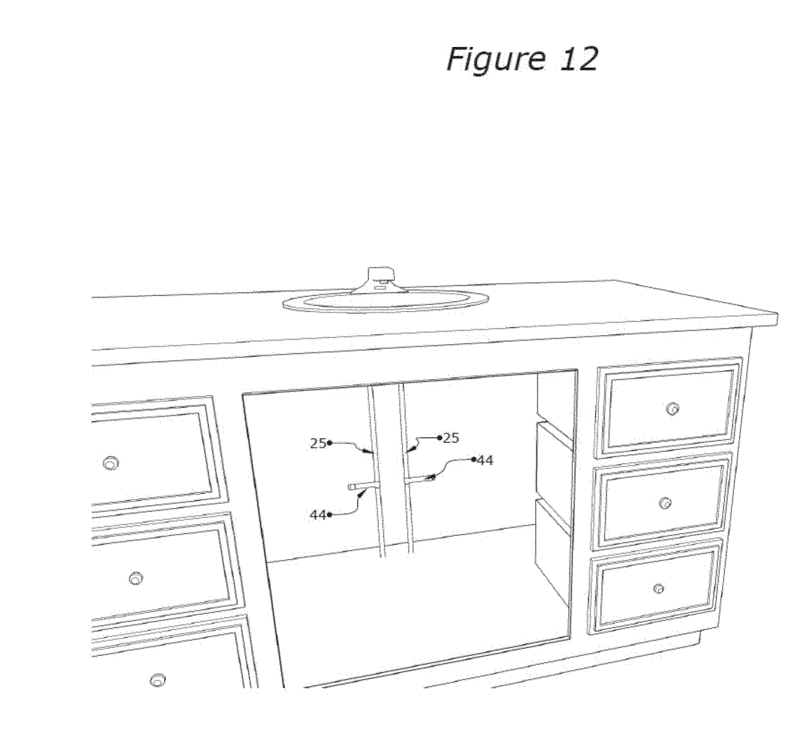

FIG. 1 illustrates an installation in a garage as near as possible to the main water supply entrance into the structure 1. The Water Control Unit 4 is installed in the main water supply the water supply out 2 then continues on to supply the plumbing system and hot water heater 12 just as it normally would. In the event of a leak, excess water or plumbing purge water will be evacuated safely outside the structure through the purge out 3. The Water Control Unit is connected through a wired interface 6 to battery backed-up electronics in the Water Control Unit Interface 5. The Water Control Unit Interface 5 handles all communications from the Water Control Unit 4 and the control panel (depicted in FIG. 13) as well as converting analog signals to digital signals from the temperature, local pressure and flow sensors depicted in FIGS. 2 and 2a as well as controlling the main water shutoff valve FIGS. 2 and 2a. The Water control Unit Interface 5 signals are sent to the control panel either through a wired low voltage network or wirelessly through a transceiver and antenna 7. Remote temperature sensors 10 sense the water temperature in various locations throughout the structure and communicate temperature to the Control Panel either wired or wirelessly. Should a freeze situation become probable the main water supply will be closed and a pump 8 will drain the plumbing system of water. To eliminate water lock, air will be introduced into the plumbing system through one-way check valves 44 installed in the plumbing system (depicted in FIG. 12) which are installed at a point or points farthest away from the pump. Power is supplied to the Water control Unit Interface 5 and pump 8 through a standard electrical outlet 11. Data communications are exchanged between the Water Control Unit Interface 5 and the Water Control Unit 4, and power supplied to the Water Control Unit 4 from the Water control Unit Interface 5 through the wired interface 6.

FIGS. 2 and 2a illustrate the Main Water Control Unit. The body of the unit 4 houses the main water shutoff valve 17 as a solenoid in FIG. 2 and separately as a motorized ball valve in FIG. 2a. The purge solenoid 16 allows water pressure to be evacuated to the outside of the structure through the purge outlet 20 or pumped out by a pump in the case of a probable freeze condition. The flow sensor 15 measures the water flow through the main supply line. The temperature sensor 14 measures the local water temperature coming from the main supply line 18 and within the Water Control Unit housing 4. Pressure is measured by a pressure sensor 13. To facilitate easier installation of plumbing fittings and to protect the unit, strain reliefs 21 are provided to give plumbers a wrench hold. FIG. 2a illustrates the same depiction as FIG. 2 except the main water valve 17 is a motor driven ball valve which is controlled by the Water Control Interface (see FIG. 1, element 5) through a low voltage connection 17a. FIG. 2a shows usage of a separate valve, which can be installed in environmentally inhospitable locations such as crawl spaces and outside the building.

FIG. 3 illustrates a sink with flow sensors or flow switches 24 installed in the supply lines 25 going to the faucet. Sensors 24 send an electrical signal through the signal wiring 23 to the transmitter 22. The transmitter then sends a signal to the control panel (FIG. 13) letting it know water is being used. The flow sensor (see FIGS. 2 and 2a, element 15) then sees water flowing and because the transmitter 22 has been programmed into the control panel the system knows that the water flow is authorized and main water valve (FIGS. 2 and 2a, element 15) remains open. When water is turned off the sensors 24 send a signal through 23 to transmitter 22 letting the control panel (see FIG. 13) know the flow has stopped. Toilets, reverse osmosis units, hose bibs and other non-powered plumbing devices or fixtures can use flow sensors or flow switches just like in this figure.

FIG. 4 illustrates a sink which is monitored by a motion detector 26. When someone approaches the sink the motion detector 26 sends a signal to the control panel (FIG. 13) letting it know water will be used. The control panel (FIG. 13) is programmed with maximum water usage and a timer is set. When there is no longer activity at the sink, the timer expires. Should water be left on accidentally, the timer will expire or usage amount will be exceeded, and the system will go into the alarm protocol.

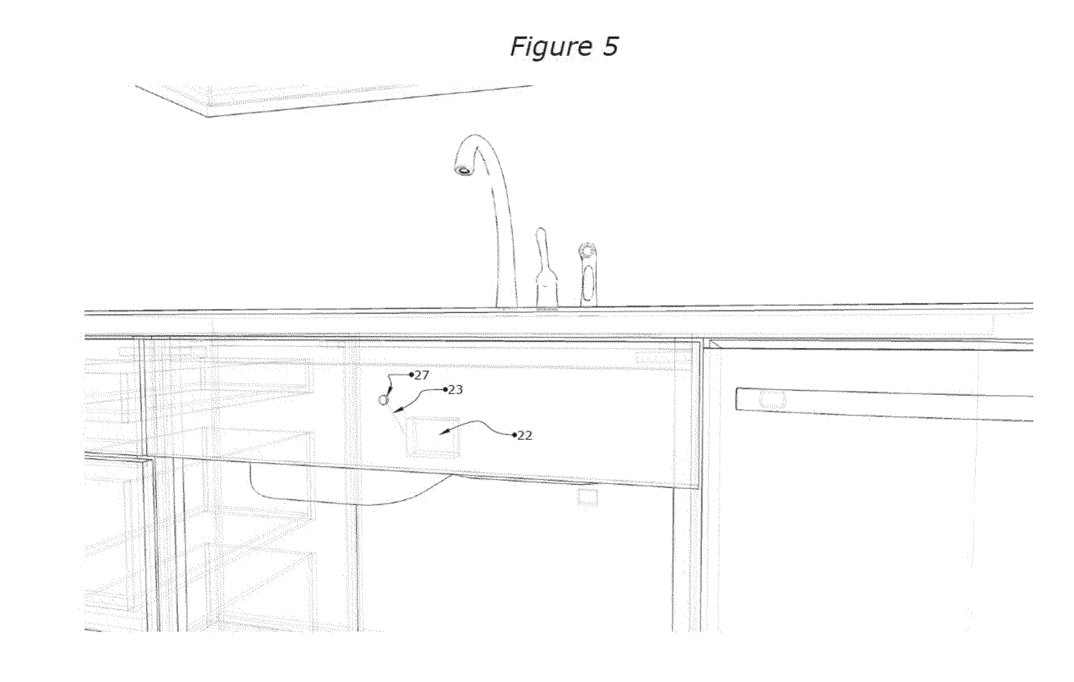

FIG. 5 illustrates a sink which is monitored by an approach sensor 27. Transmitter 22 and signal wiring 23 operate as described above. When someone approaches the sink the sensor 27 sends a signal to the control panel (FIG. 13) letting it know water is being used. The control panel (FIG. 13) is programmed with maximum water usage and a timer is set. When there is no longer activity at the sink, the timer expires. Should water be left on accidentally the timer will expire or usage amount will be exceeded, and the system will go into the alarm protocol.

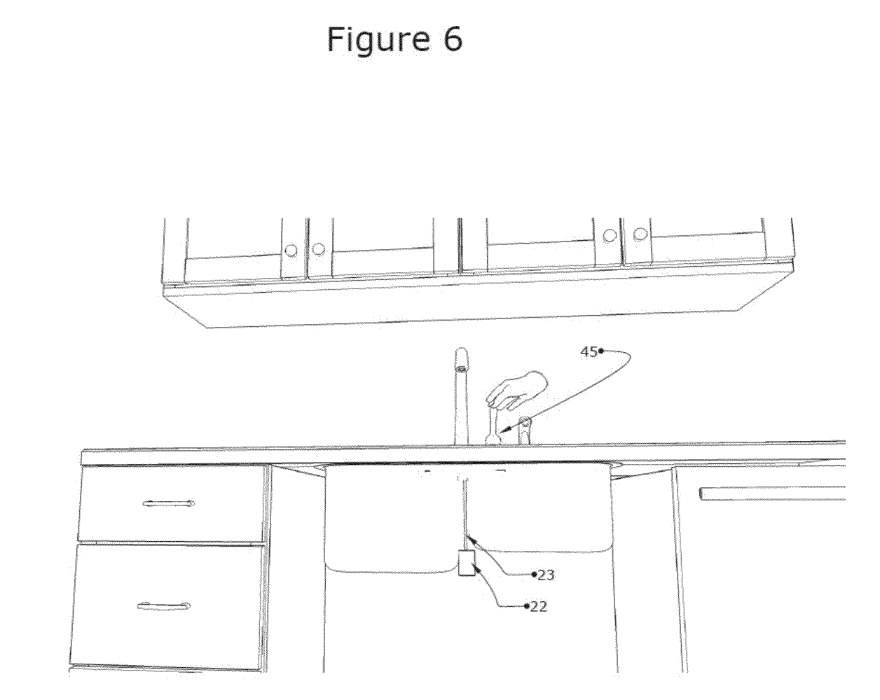

FIG. 6 illustrates a sink which is monitored by a touch sensor 27. Transmitter 22 and signal wiring 23 operate as described above. When someone touches the sink the sensor 27 notifies sends a signal to the control panel (FIG. 13) letting it know water is being used. The control panel (FIG. 13) is programmed with maximum water usage and a timer is set. Should water be left on accidentally the timer will expire or usage amount will be exceeded, and the system will go into the alarm protocol.

FIG. 7 illustrates an appliance sensor. The figure depicted is a refrigerator, however all powered water-using appliances operate on the same principle, whether dishwasher, clothes-washing machine, water dispenser and/or icemaker in refrigerator, stand-alone icemaker, humidifier or any other powered water-using appliance or device. The access panel 33 allows access to the solenoid(s) 32 which controls water flowing from the water supply in 30 providing water to the appliance (ice maker in this figure) through the water delivery 31 to the ice maker. After the refrigerator empties the ice tray it sends power to the solenoid through the power cables 29 activating the solenoid 32 refilling the ice tray with water through when power is present in 29 an inductive clip 28 senses the power and activates the transmitter 22 which follows the same communication protocol described above. When power is no longer present in power cables 29 the inductive clip 28 senses the power loss and the transmitter sends a signal to the control panel letting it know water is no longer needed. As in all above fixtures maximum water usage (flow) is programmed into the control panel during installation so the control panel can monitor for a leak during water usage or a malfunction in the appliance. A timer is set for each transmitter 22 individually and should the appliance malfunction and fail to turn off the solenoid 32 the timer will expire and the main water supply will be turned off and the alarm protocol will be initiated. While inductive pickups 28 are used here, any type of hardwired sensor, flow sensor or switch may be used. This same configuration can be used in all appliances.

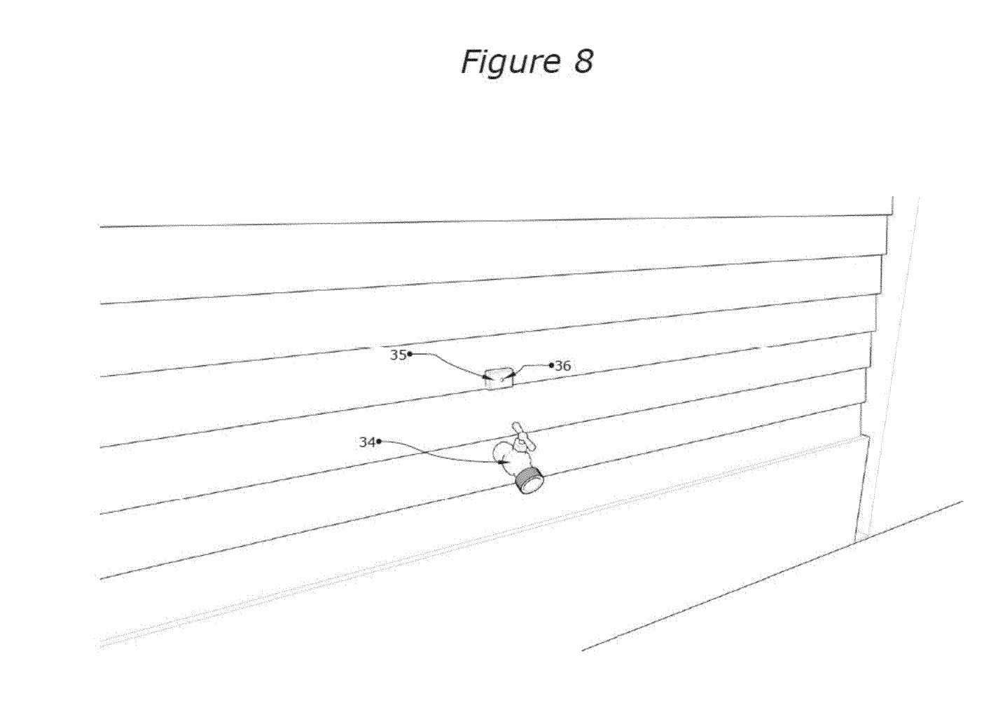

FIG. 8 illustrates a hose bib located on the outside of the building. When the hose bib 34 is going to be used the user presses the button 36 on the waterproof transmitter 35 and the transmitter tells the control panel that water will be used at that location and a timer is set. Timers are custom-programmed for typical usage at each location. Maximum flow is also programmed into the control panel. As above, should water be left on or maximum usage exceeded, control panel will close main water control valve and initiate the alarm protocol.

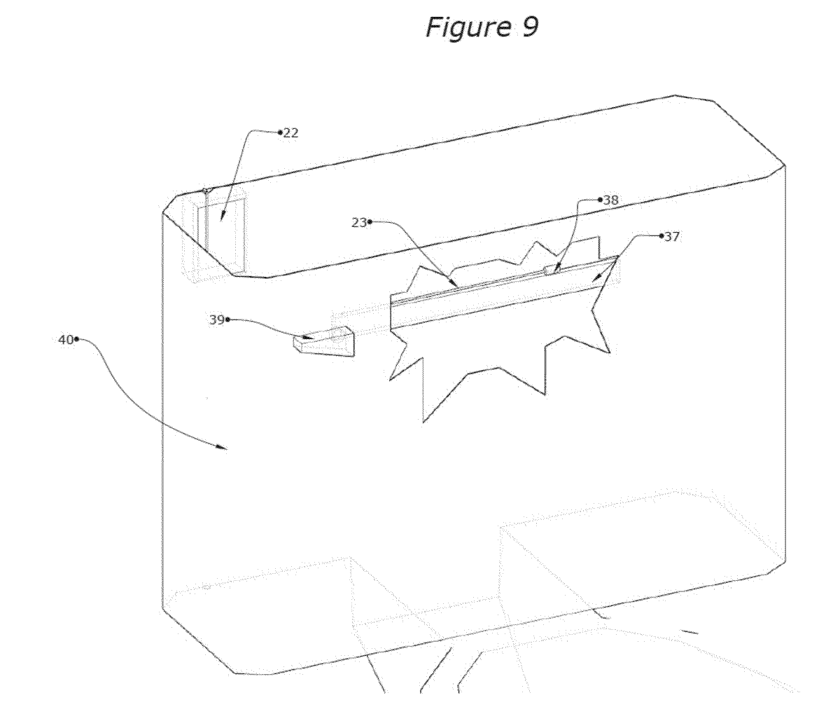

FIG. 9 illustrates a possible toilet and toilet tank 40 application. When the flush handle 39 is pushed a tilt switch 38 sends a signal through the wire 23 to the transmitter 22 to the control panel. Typical communication protocol is followed and a timer is set. Should the flapper valve hang, the control panel will turn off the main water valve and alarm protocol will be followed. A timer is set in case the flapper hangs, conserving water and eliminating the likelihood of overflow. Various types of sensors can be used for toilets including flow switches such as in FIG. 3, motion detectors, or any other type of sensor than can be used on a sink or faucet.

FIG. 10 illustrates a possible shower sensor. A motion sensor 26 is used in this instance to indicate water is to be used in the shower. Motion sensors can be used in the same way for any number of fixtures or locations.

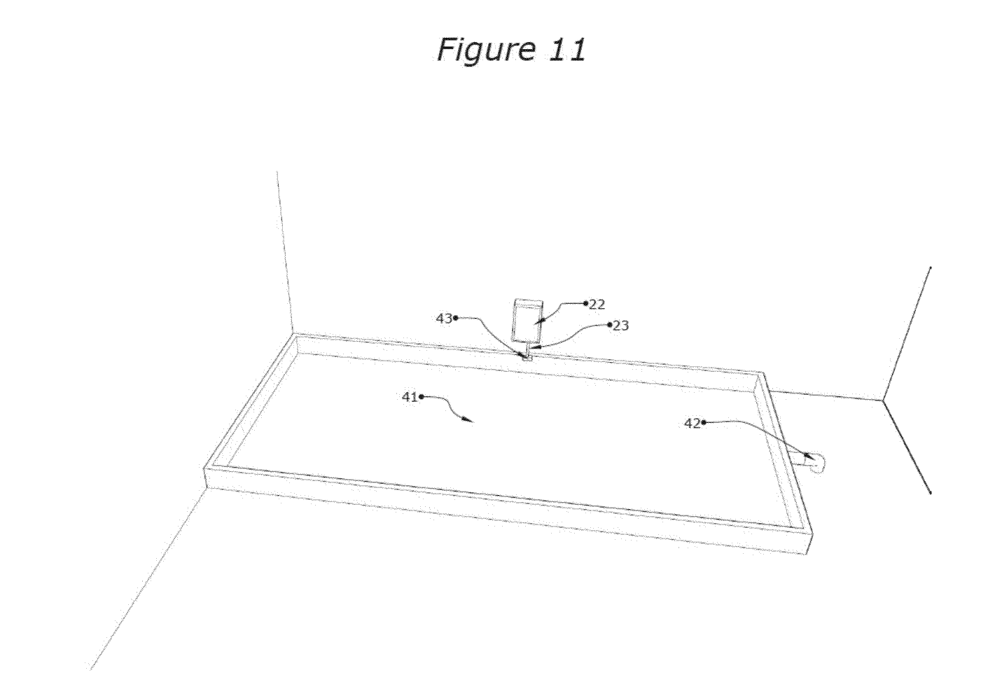

FIG. 11 illustrates a moisture sensor 43 connected by a signal wire 23 to a transmitter 22. Should the water level rise to the level of the sensor 43 the transmitter will send an alarm signal to the control panel and the control panel will alarm and send a notification to the user's cell phone indicating water level has risen too high in the air conditioner drip pan. This configuration can be used in any location where water can accumulate such as a basement etc., or where water can overflow or rise to a maximum level such as a Jacuzzi tub, pool etc. indicating the water supply to that location needs to be turned off.

FIG. 12 illustrates a one-way check valve installation. One-way check valves 44 are installed in conjunction with the pump installation in the supply lines 25 in order to prevent water-lock when the pump is energized to purge the water from the supply lines. These valves allow air to flow into the plumbing system so water may be pumped out and should be located at the farthest point or points from the pump.

FIG. 13 illustrates the Control Panel set at the system status page.

It will be understood that the embodiments of the invention are not limited or restricted to any particular form of faucet sensing device or application to a particular method of detecting water usage at a location. Any sensing method can be used at any location, fixture or water-using appliance.

The above presents a description of the best mode contemplated for carrying out water leak detection and prevention systems and methods in such full, clear, concise and exact terms as to enable any person skilled in this art to which it pertains to make and use these systems and methods. These systems and methods are, however, susceptible to modifications and alternate constructions from that discussed above that are fully equivalent. Consequently, these systems and methods are not limited to the particular embodiments disclosed. On the contrary, these systems and methods cover all modifications and alternate constructions coming within the spirit and scope of the present invention.

Water leak detection and prevention systems and methods herein outlined will monitor water usage in all locations, faucets, fixtures and water using appliances by measuring flow and calculating how much water should be flowing into the structure based upon predetermined usage at every water outlet. Should flow exceed maximum allowed, flow will be terminated by closing the main water valve and going into the alarm protocol. Additionally, a periodic pressure test will be performed during periods of low water usage to check for very slow leaks. This is the same type of pressure test a plumber performs on a new construction for code inspection only this system uses water instead of air. If the system discovers a leak, alarm protocol will be initiated and data concerning quantity of water being leaked will be reported to the system and available for the homeowner and plumber repairing the leak.

In some existing systems for water leak detection, a main valve opens and shuts each time water is used. In contrast, the present invention remains open continuously to supply water instantly upon demand until a leak is detected. The advantage of the present invention over the previous implementations is that there is significantly less wear and tear on the valve so that the main valve lasts considerably longer. Also, there is no delay when water is called for at a faucet or appliance, thereby preventing certain undesirable sounds or operations.

In certain prior art systems based on detecting changes in water pressure as opposed to water flow, such systems can only detect a leak when the water is off everywhere in the building, while water is being used anywhere in the building such systems cannot detect a leak. The advantage of the present invention is that leaks can be detected while the water is being used because the flow rate of each location is programmed into the system. Therefore, excess flow rates are detected as opposed to just water pressure. In other words, flow is being monitored at all times, if more flow is occurring than is supposed to, our device will shut the water off if a leak happens at any time, whether water is being used or not.

What is claimed is:

1. A method for protecting a home or business building from flooding caused by a leak or rupture in the building plumbing or a malfunctioning appliance comprising:
when no fixture or water-using appliance (e.g., faucet, toilet, shower, dishwasher, clothes washer, refrigerator, humidifier, reverse osmosis unit, water treatment unit, thermal solar panel, etc.) demands water, a flow sensor detects water leakage and determines an amount of water that has been leaked;
water to the building is turned off and water in a plumbing system is purged safely outside the building;
each plumbing fixture and water-using appliance is monitored by a sensor and communicates wirelessly with a control panel that monitors flow of water through a main plumbing supply;
the control panel is programmed with a location of each fixture or appliance and a maximum amount of water that fixture or appliance uses
should the flow sensor detect water usage in excess of an allowed limit for that fixture or appliance, water will be turned off and any water in the plumbing system will be purged safely outside the building.

2. The method according to claim 1, wherein each said faucet and water-using appliance will use water for a period of time specified for that location or upon an indication from the sensor that water is no longer needed.

3. A method for detecting a water leak wherein water flow is detected and no authorized location has called for water, water supply will be turned off, an alarm will sound and a signal will be sent wirelessly to the user's cell phone indicating there has been a water leak and the building has been protected and that user needs to have the leak fixed.

4. A method wherein water usage for various periods (day, week, month, year) will be listed on the control panel and water bill can be calculated based upon municipal supply water prices, wherein this data can be sent to the user's cell phone and this function will allow the user to monitor water usage real-time, know what water costs are and help user conserve water.

5. A method wherein water temperature will be monitored at various locations simultaneously, should water temperature drop near freezing, main water valve will close and water will be pumped from the supply lines to the outside of the building via a pump connected to the system, wherein this data can be sent wirelessly to the user's cell phone and, air temperature outside the building and water temperature within the building can be monitored and temperature projections by the National Weather Service for the area communicated to the control panel, which can analyze the data to project a plumbing freeze possibility, and should there be a likelihood of a freeze within the next 8 hours or so, the control panel will sound a freeze warning indicating a possible freeze condition, which data can be sent to the user's cell phone alerting user that conditions indicate a possible freeze of the water in the plumbing system hours before freeze conditions occur, allowing the user to take precautions.

6. A method wherein areas in which water can collect or overflow will be monitored by a moisture sensor, a signal communicated wirelessly to the control panel, and this data can be sent to the user's cell phone.
